(19) United States
(12) Patent Application Publication
(10) Pub. No.: US 2001/0003090 A1
(43) Pub. Date: Jun. 7, 2001

(54) ELECTRONIC DEVICE WITH TWO USEFUL FACES INCLUDING A PROTECTION MEANS

(76) Inventor: PERNILLA JOHANSSON, LE MANS (FR)

Correspondence Address: U.S. PHILIPS CORPORATION, 580 WHITE PLAINS ROAD, TARRYTOWN, NY, 10591

(21) Appl. No.: 09/038,568

(22) Filed: Mar. 11, 1998

(30) Foreign Application Priority Data
Mar. 11, 1997 (FR) 9702865

(51) Int. Cl. H04B 1/38

(52) U.S. Cl. 455/90; 455/550; 455/575; 379/433; 455/434; 455/437; 361/724; 206/307.1

(57) ABSTRACT

The device may be formed by joining together two devices which have each a main face with a keyboard or a display, the main faces being turned away from each other. The device may also be a monoblock with two useful faces which are turned away from each other.

The device comprises a flexible or rigid protection strip fastened by one of its ends to the device so that the strip is capable of covering either the one main face or the other main face.

Applications: Calculators, telephones, pagers, remote controls, organizers and other calculation and communication devices.

The present invention relates to an electronic device which has a main face with means for interaction with a user, such as a keyboard and/or a display, which device is suitable for having joined thereto a second device which also has a main face with means for interaction with a user and which, when a second device is connected thereto, forms a combined device whose two main faces are turned away from each other. The invention also relates to a monoblock having two main faces which are turned away from each other and have each means for interaction with a user, such as a keyboard and/or a display.

A device having two main faces with means for interaction with a user, such as a keyboard and/or a display, is known from the document PCT WO 93/12604. According to this document, a telephone having a main face with means for interaction with a user is associated to a calculator which also has a main face with means for interaction with a user. These two devices together form a single combined device whose two main faces are turned away from each other.

The invention proposes to improve the protection of the device.

For this purpose, the device has a flexible or slewable protection strip which is fastened by one of its ends to the device so that in the case of a combined device this strip is suitable for covering at least partly the main face of the first device or the main face of the second device.

In the case of a monoblock, the device has a flexible or slewable protection strip which is fastened by one of its ends to the device so that this strip is suitable for covering at least partly either main face of the device.

When a user uses either of the two useful faces, such a strip permits of protecting the other useful face which rests, for example, on a table or on another support.

In the case of two combined devices, the first device is advantageously a personal organizer which includes means for receiving a mobile telephone as a second device, or also the first device is a mobile telephone including means for receiving a personal organizer as a second device.

The combination of a mobile telephone with another device, notably an organizer, is interesting, as, for example, the organizer makes it possible to note down at once information obtained through the telephone.

In that case, the protection strip advantageously has openings which are situated facing an earphone and a microphone when the strip covers the main face of a telephone.

Thus, the telephone can be used even when it is covered by the strip.

In a particular embodiment, the strip has on its other end an immobilization means which comprise in one embodiment at least a magnet fixed to the strip and a magnetic piece fixed to the device, or the other way around, and in another embodiment, strips allowing of adhering to each other known by the name of “Velcro”.

It is useful to provide a rigid central part of the strip.

Thus, when one face is used, an undesired depression of a key on the other face is avoided.

These and other aspects of the invention will be apparent from and elucidated with reference to the embodiments described hereinafter.

In the drawings:

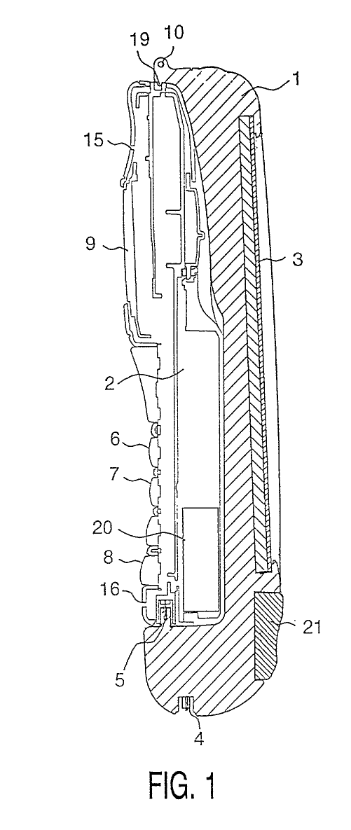

FIG. 1 represents in a side view a combined electronic assembly formed by two devices,

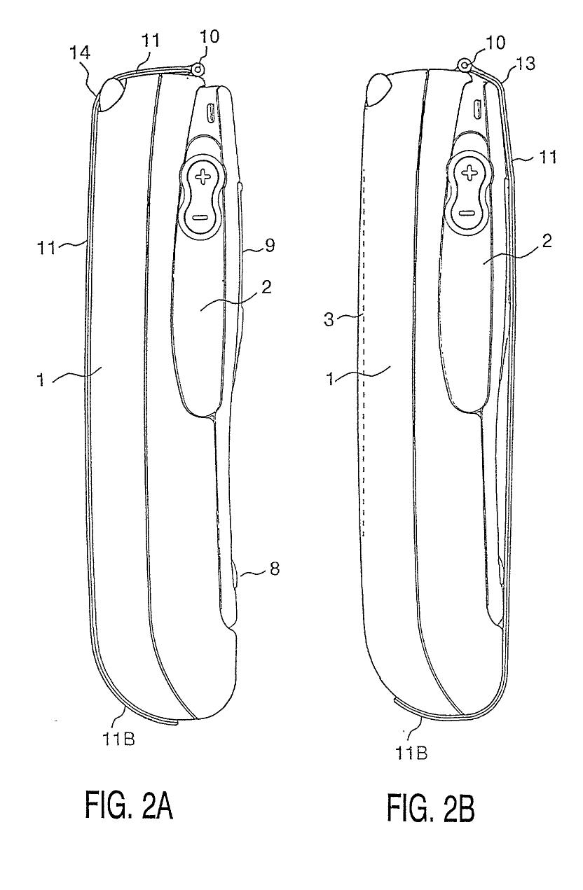

FIG. 2 is a side view of a combined electronic assembly with a protection strip illustrating two positions of the strip, and

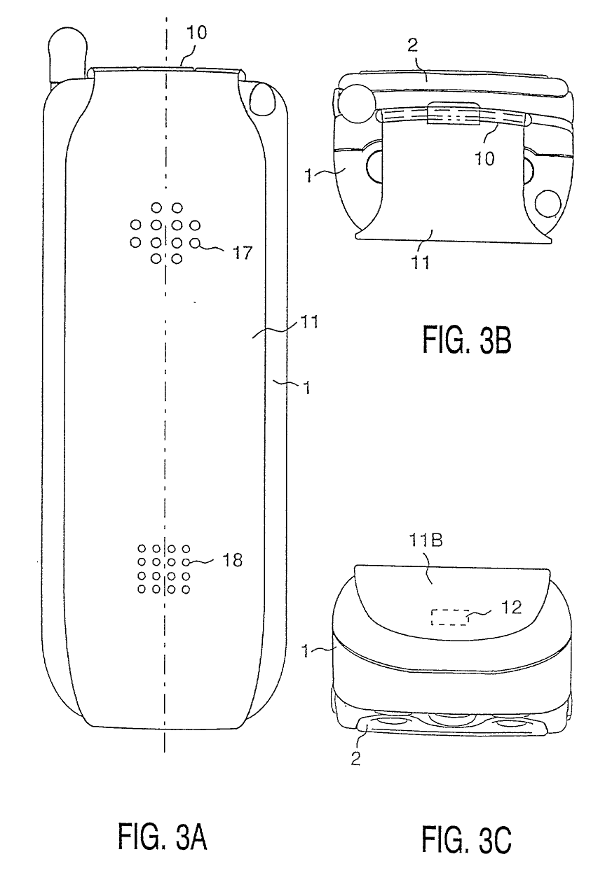

FIG. 3 is a front view, a plan view, and a bottom view of a combined electronic assembly with a protection strip.

The assembly of FIG. 1 comprises an electronic device 1 which is here, by way of example, of a type known as a personal organizer. It has a main face with means for interaction with a user, here a display screen 3 which has sensitive zones allowing the user to enter information by touching the screen, and also a pointer element 21 of the track ball type. Reference 10 indicates a hinge whose role will be described with reference to FIG. 2. To this device is attached a second device 2 which is here a mobile telephone and which has a main face with means for interaction with a user, that is, a screen 9 and keys 6, 7, 8. The main faces of the two devices 1 and 2 are turned away from each other.

Such a device is shown by way of example, but any other device, notably a monoblock having two main faces with means for interaction with a user, such as a keyboard and/or a display, for example a sophisticated remote control for a video recorder may also comprise the means to be described hereinafter.

In FIG. 2, the device has a protection strip 11, for example, of leather or of a flexible plastic material, fastened here by one of its ends via a hinge 10 to the top of the device. This strip is suitable for at least partly covering the face turned to the left as this is represented in A, or, by returning the strip, the face turned to the right as is represented in B. The strip has immobilization means, that is to say, fixing means at its other end 11B here at the bottom. The strip could also adopt the form of a curtain mounted on a roller, which roller may possibly be situated inside the body of the device.

It will be obvious that the term of strip could also refer to a relatively rigid element, a sort of blade of, for example, plastic material which could be hinged or would comprise a flexible intermediate part at the level of the bends referenced 13 and 14.

FIG. 3 shows the same device assembly from another point of view. FIG. 3A particularly shows the central part of the strip 11 covering the device. The central part of the strip may be made more rigid so as to protect the keys against undesired depression. The strip has openings 17, 18 which are facing the earphone and the microphone of the telephone.

FIG. 3B particularly shows the end of the strip 11 fastened to the device 1 by the hinge 10. FIG. 3C particularly shows the other end 11B of the strip with the immobilization means which comprise here a magnet 12 fixed to the strip (or in the device) and a magnetic part (not shown), fixed correspondingly in the personal organizer 1 (or fixed to the strip, respectively).

Some variants may be considered, for example:

the immobilization means may be formed by “Velcro” tapes;

instead of the hinge 10 may be used another known fastening means;

the strip may also be completely removable: the hinge itself may be detachable from the body of the device, either the strip may be attached by clipping or by sliding into a suitable support, or, like at the other end 11B, by a system of a magnet/magnetic part, or by “Velcro”.

the strip may be shorter than shown in the Figure at its end 11B, which end may, for example, be suitable for reaching the bottom of the main face of each of the devices and no longer the bottom of the first device. In that case a magnetic member should be provided on the personal organizer and another magnetic member on the telephone.

1. An electronic device which has a main face with means for interaction with a user, such as a keyboard and/or a display, which device is suitable for having joined thereto a second device which also has a main face with means for interaction with a user and which, when a second device is connected thereto, forms a combined device whose two main faces are turned away from each other, characterized in that the device has a flexible or slewable protection strip which is fastened by one of its ends to the device so that in the case of a combined device this strip is suitable for covering at least partly the main face of the first device or the main face of the second device.

2. The device as claimed in claim 1, characterized in that the first device is a personal organizer and means are provided for receiving a mobile telephone as a second device.

3. The device as claimed in claim 1, characterized in that the first device is a mobile telephone and means are provided for receiving a personal organizer as a second device.

4. A device as claimed in one of the claims 2 or 3, characterized in that the strip has openings which are situated facing an earphone and a microphone when the protection strip covers the main face of a telephone.

5. An electronic device having two main faces which are turned away from each other and have each means for interaction with a user, such as a keyboard and/or a display, characterized in that it has a flexible or rigid protection strip which is fastened by one of its ends to the device so that this strip is suitable for covering at least partly either main face of the device.

6. A device as claimed in any one of claims 1 to 5, characterized in that the protection strip has immobilization means at its other end.

7. The device as claimed in claim 6, characterized in that the immobilization means comprise at least a magnet fastened to the protection strip and a magnetic member fastened to the device, or the other way around.

8. The device as claimed in claim 6, characterized in that the immobilization means are formed by tapes which are suitable for adhering to each other known by the name of “velcro”.

9. A device as claimed in any one of the claims 1 to 8, characterized in that a central part of the strip is rigid.
